(19) United States
(12) Patent Application Publication
(10) Pub. No.: US 2010/0321957 A1
(43) Pub. Date: Dec. 23, 2010

(54) STANDBY POWER METHOD AND APPARATUS FOR POWER MODULE APPLICATIONS

(75) Inventors: Chang-Ling Sha, Hsin-Chu City (TW); Ko-Ming Lin, Hsin-Chu City (TW); Chi-Hao Wu, Hsin-Chu City (TW); Huang-Chi Lin, Hsin-Chu City (TW)

Correspondence Address: APEX JURIS, PLLC, 12733 LAKE CITY WAY NORTHEAST, SEATTLE, WA, 98125, US

(73) Assignee: GRENERGY OPTO, INC., Hsin-Chu City (TW)

(21) Appl. No.: 12/486,302

(22) Filed: Jun. 17, 2009

(51) Int. Cl. H02M 3/335

(52) U.S. Cl. 363/20

(57) ABSTRACT

The present invention discloses a standby power saving method for power module applications, comprising the steps of: generating a mode signal according to voltage comparison of a feedback signal and a threshold voltage, wherein the mode signal has a normal mode state and a standby mode state; generating a pulse signal according to the mode signal, wherein the pulse signal has a normal PWM mode responsive to the normal mode state of the mode signal, and a V_{CC} mode responsive to the standby mode state of the mode signal; and generating a gating signal according to the pulse signal for driving a primary side power switch. The present invention also provides a standby power saving apparatus for power module applications.

### BACKGROUND OF THE INVENTION

1. Field of the Invention

The present invention relates to switching power conversions, and more particularly relates to switching power conversions capable of reducing standby power consumption.

2. Description of the Related Art

In supplying the power for electronic equipments, switching power converters are widely adopted due to the advantages of high conversion efficiency and small component size they possess.

Taking the fly-back AC-to-DC power adapter as an example, FIG. 1 shows the circuit diagram of a typical fly-back AC-to-DC power adapter. As shown in FIG. 1, the typical fly-back AC-to-DC power adapter includes an input rectification and filtering unit 101, a primary side voltage clamping snubber 102, a main transformer 103, a diode 104, a capacitor 105, a resistor 106, a resistor 107, a resistor 108, a programmable shunt regulator 109, a photo-coupler 110, a PWM IC 111, an auxiliary coil 112, a diode 113, a capacitor 114, an NMOS transistor 115 and a resistor 116.

In the architecture, the input rectification and filtering unit 101 is used to generate a main input voltage according to an AC input.

The primary side voltage clamping snubber 102 is used to clamp the maximum primary side voltage of the main transformer 103 when the NMOS transistor 115 is off.

The main transformer 103, having a primary side coupled to the main input voltage and a secondary side coupled to the diode 104, is used to convert power from the AC input to the DC output of the adapter.

The diode 104 and the capacitor 105 are used as an output rectification and filtering unit to generate a DC output voltage Vₒᵤₜ.

The resistor 106, resistor 107, resistor 108, programmable shunt regulator 109 and photo-coupler 110 are used to generate a feedback signal V_{FB}, which is coupled to the COMP pin of the PWM IC 111, according to an error signal derived from a reference voltage and the DC output voltage Vₒᵤₜ.

The PWM IC 111 is used to generate a gating signal V_{G} according to the feedback signal V_{FB} and a current sensing signal V_{CS} to regulate the DC output voltage Vₒᵤₜ at an expected level.

The auxiliary coil 112, diode 113 and capacitor 114 are used to generate a DC supply voltage V_{CC} for the operation of the PWM IC 111.

The NMOS transistor 115, responsive to the gating signal V_{G}, is used to control the power conversion via the main transformer 103.

The resistor 116 is used to carry the current sensing signal V_{CS}.

Through a periodic on-and-off switching of the NMOS transistor 115, which is driven by the gating signal V_{G} generated from the PWM IC 111, the input power is transformed through the main transformer 103 to the output.

However, when the powered electronic equipment enters standby mode, the power delivered by the typical adapter of FIG. 1 seems excessive.

One solution that conventional power converters utilize to solve this problem is to add an enable pin on the PWM IC and add a second photo-coupler for receiving a control signal from the powered electronic equipment.

Please refer to FIG. 2, which shows the circuit diagram of a prior art fly-back AC-to-DC power adapter supporting standby mode. As shown in FIG. 2, the prior art circuit includes an input rectification and filtering unit 201, a primary side voltage clamping snubber 202, a main transformer 203, a diode 204, a capacitor 205, a resistor 206, a resistor 207, a resistor 208, a programmable shunt regulator 209, a photo-coupler 210, a PWM IC 211, an auxiliary coil 212, a diode 213, a capacitor 214, an NMOS transistor 215, a resistor 216 and a photo-coupler 217.

Since most of the components of the circuit in FIG. 2 have been specified above, the description of FIG. 2 will be focused on the photo-coupler 210, the PWM IC 211 and the photo-coupler 217.

The photo-coupler 210 is used to generate a feedback signal V_{FB}, which is coupled to the COMP pin of the PWM IC 211, according to an error signal derived from a reference voltage and the DC output voltage Vₒᵤₜ.

The PWM IC 211 has an enable pin IC_EN in addition to the COMP pin. The COMP pin is coupled to an output side of the photo-coupler 210 to receive the feedback signal V_{FB}. The enable pin IC_EN is coupled to an enable signal V_{EN} from an output side of the photo-coupler 217, and the PWM IC 211 will enter standby mode to reduce the power converted to the electronic equipment when the enable signal V_{EN} is pulled down to a low level.

The photo-coupler 217 has an input side coupled to a control signal V_{CONTROL} from the electronic equipment and the output side for generating the enable signal V_{EN}, which is coupled to the enable pin IC_EN of the PWM IC 211. As shown in FIG. 2, the control signal V_{CONTROL} has the high level standing for the standby mode request and the low level standing for a normal PWM mode request. When the control signal V_{CONTROL} is at the high level, the enable signal V_{EN} will be pulled down to a low level.

However, the additional photo-coupler 217 and the additional enable pin IC_EN for the PWM IC 211 will increase the cost of the adapter, and the fact that the DC output voltage Vₒᵤₜ remains the same for the standby mode and the normal PWM mode due to the effect of the feedback signal V_{FB} will cause the adapter to convert excessive power to the electronic equipment in standby mode, since the operation voltage of the electronic equipment in standby mode can be lower than that in the normal PWM mode.

Therefore, there is a need to provide a solution capable of lowering the DC output voltage Vₒᵤₜ in standby mode without any additional photo-coupler or additional enable pin for the PWM IC.

Seeing this bottleneck, the present invention proposes a novel adapter topology without any additional photo-coupler or additional enable pin for the PWM IC to lower the DC output voltage Vₒᵤₜ in standby mode in response to a control signal from an electronic equipment.

### SUMMARY OF THE INVENTION

One objective of the present invention is to provide a standby power saving method for a switching power converter to lower the DC output voltage in standby mode without any additional photo-coupler or additional enable pin for the PWM IC.

Another objective of the present invention is to further provide a standby power saving apparatus for a switching power converter to lower the DC output voltage in standby mode without any additional photo-coupler or additional enable pin for the PWM IC.

To achieve the foregoing objectives of the present invention, a standby power saving method for power module applications is proposed, the method comprising the steps of: generating a mode signal according to voltage comparison of a feedback signal and a threshold voltage, wherein the mode signal has a normal mode state and a standby mode state; generating a pulse signal according to the mode signal, wherein the pulse signal has a normal PWM mode responsive to the normal mode state of the mode signal, and a V_{CC} mode responsive to the standby mode state of the mode signal; and generating a gating signal according to the pulse signal for driving a primary side power switch.

To achieve the foregoing objectives, the present invention further provides a standby power saving apparatus for power module applications, comprising: a mode detector, used for generating a mode signal according to voltage comparison of a feedback signal and a threshold voltage, wherein the mode signal has a normal mode state and a standby mode state; a V_{CC} mode unit, used for generating a pulse signal according to the mode signal, wherein the pulse signal has a normal PWM mode responsive to the normal mode state of the mode signal, and a V_{CC} mode responsive to the standby mode state of the mode signal; and a driver, used for generating a gating signal according to the pulse signal for driving a primary side power switch.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 is the circuit diagram of a typical fly-back AC-to-DC power adapter.

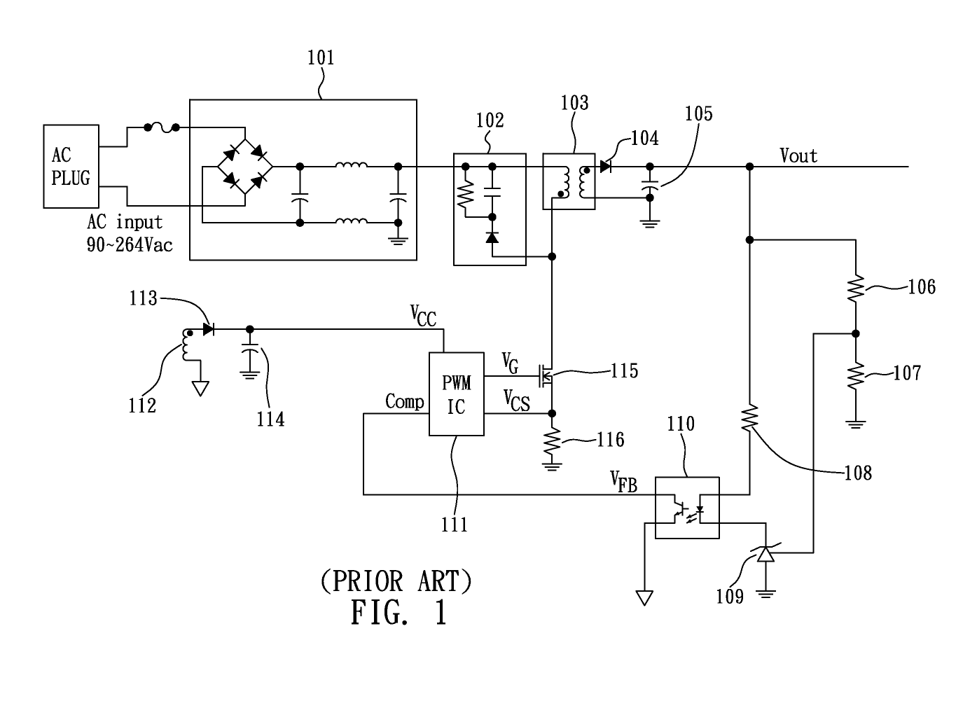

FIG. 2 is the circuit diagram of a prior art fly-back AC-to-DC power adapter supporting standby mode.

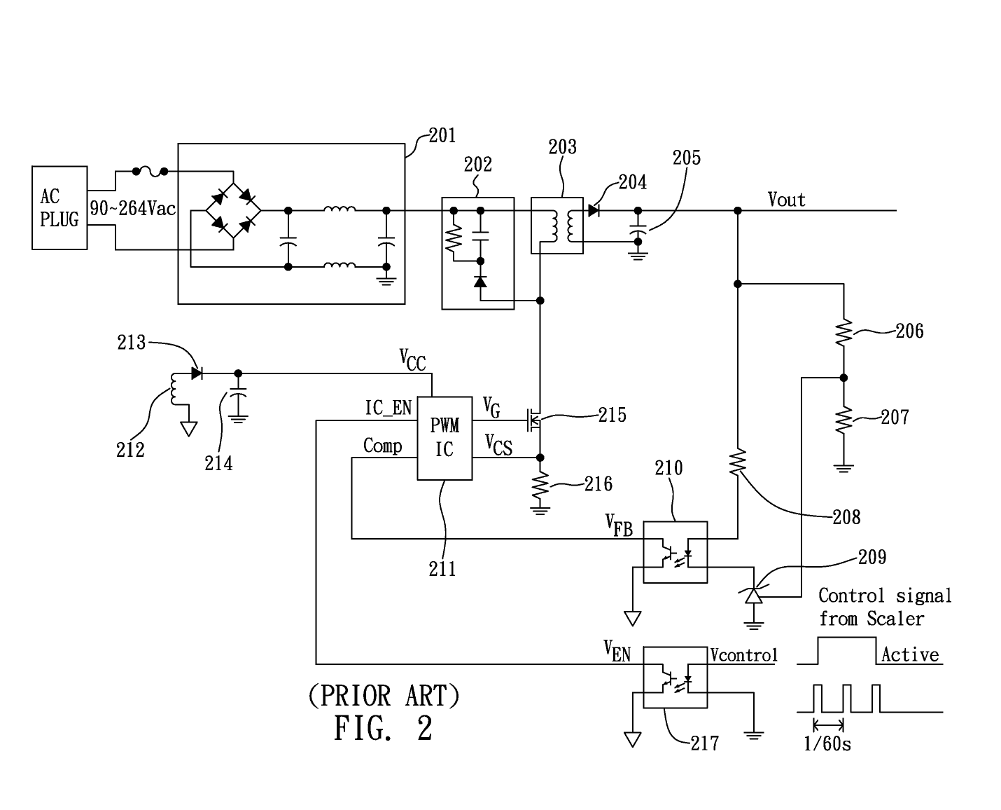

FIG. 3 is the circuit diagram of a fly-back AC-to-DC power adapter supporting standby mode according to a preferred embodiment of the present invention.

FIG. 4 is the flow chart of a standby power saving method for an AC-to-DC power adapter according to a preferred embodiment of the present invention.

FIG. 5 is the block diagram of a standby power saving apparatus for an AC-to-DC power adapter according to a preferred embodiment of the present invention.

FIG. 6 is the waveform diagram of the DC supply voltage V_{CC} of the standby power saving apparatus in standby mode according to a preferred embodiment of the present invention.

FIG. 7 is the waveform diagram of a DC output voltage Vₒᵤₜ of an AC-to-DC power adapter in standby mode according to a preferred embodiment of the present invention.

### DETAILED DESCRIPTION OF THE PREFERRED EMBODIMENTS

The present invention will be described in more detail hereinafter with reference to the accompanying drawings that show the preferred embodiment of the invention.

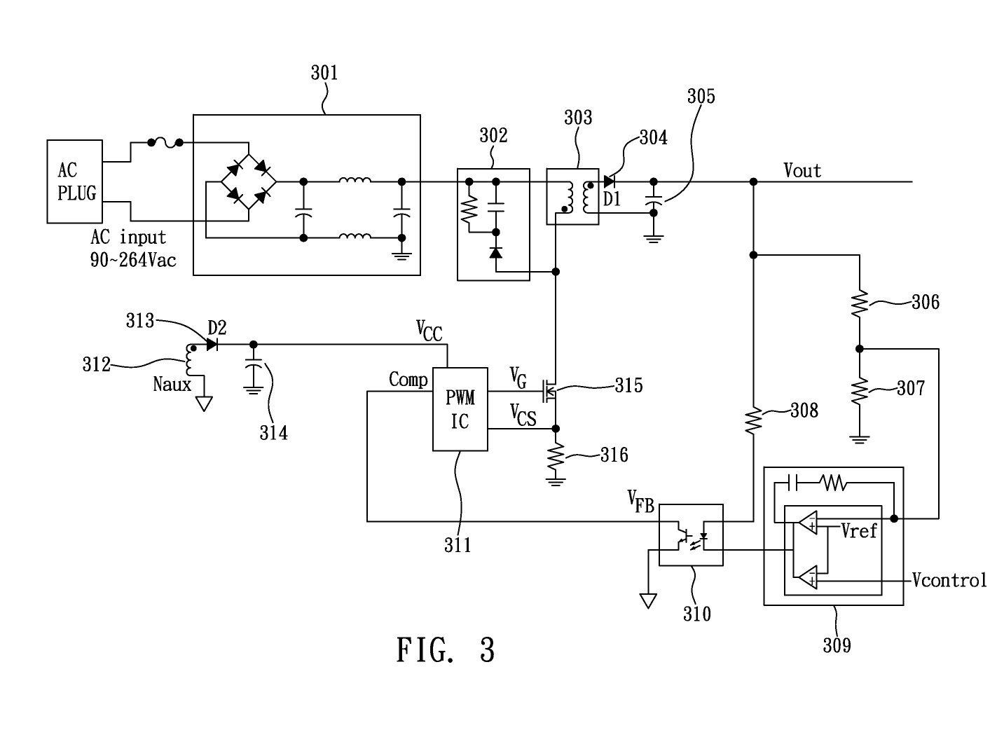

Please refer to FIG. 3, which shows the circuit diagram of a fly-back AC-to-DC power adapter supporting standby mode according to a preferred embodiment of the present invention. As shown in FIG. 3, the circuit according to a preferred embodiment of the present invention includes an input rectification and filtering unit 301, a primary side voltage clamping snubber 302, a main transformer 303, a diode 304, a capacitor 305, a resistor 306, a resistor 307, a resistor 308, a programmable shunt regulator 309, a photo-coupler 310, a PWM IC 311, an auxiliary coil 312, a diode 313, a capacitor 314, an NMOS transistor 315 and a resistor 316.

In the architecture, the input rectification and filtering unit 301 is used to generate a main input voltage according to an AC input.

The primary side voltage clamping snubber 302 is used to clamp the maximum primary side voltage of the main transformer 303 when the NMOS transistor 315 is off.

The main transformer 303, having a primary side coil with N_{P} turns coupled to the main input voltage and a secondary side coil with N_{S} turns coupled to the diode 304, is used to convert power from the AC input to the output of the adapter.

The diode 304 and the capacitor 305 are used as an output rectification and filtering unit to generate a DC output voltage Vₒᵤₜ.

The resistor 306, resistor 307, resistor 308, programmable shunt regulator 309 and photo-coupler 310 are used to generate a feedback signal V_{FB}, which is coupled to the COMP pin of the PWM IC 111, according to an error signal derived from a reference voltage and the DC output voltage Vₒᵤₜ when a control signal V_{control}.is at an active state. When the control signal V_{control}.is at a standby state, the feedback signal V_{FB} will be pulled down to a low level.

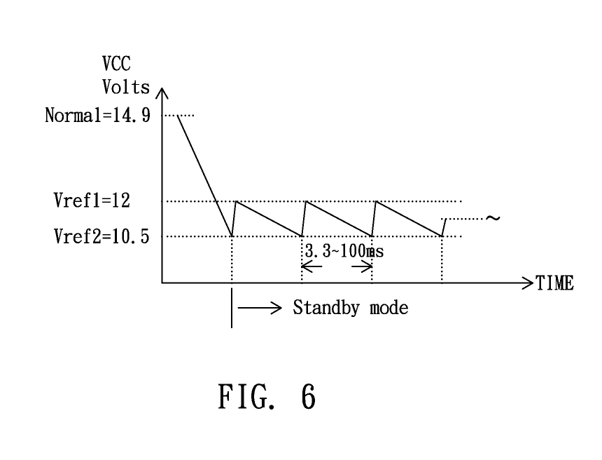

The PWM IC 311 can operate in a normal PWM mode or in a V_{CC} mode according to the state of the feedback signal V_{FB}. When the feedback signal V_{FB} is not pulled down to a low level, the PWM IC 311 will operate in the normal PWM mode and generate a gating signal V_{G} according to the feedback signal V_{FB} and a current sensing signal V_{CS} to regulate the DC output voltage Vₒᵤₜ at an expected level, wherein the feedback signal V_{FB} is coupled to the COMP pin of the PWM IC 111. When the feedback signal V_{FB} is pulled down to a low level, the PWM IC 311 will operate in the V_{CC} mode and generate a gating signal V_{G} according to a DC supply voltage V_{CC} so that the DC supply voltage V_{CC} will be kept within a range from a first reference voltage to a second reference voltage. As shown in FIG. 6, when in standby mode, the DC supply voltage V_{CC} is kept within a range from a first reference voltage 12V to a second reference voltage 10.5V.

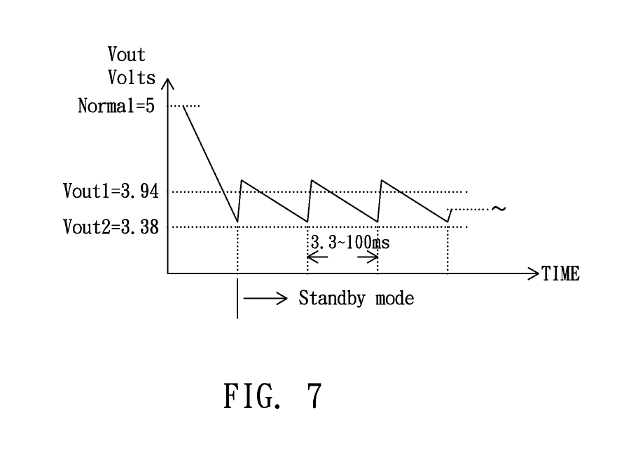

The auxiliary coil 312, diode 313 and capacitor 314 are used to generate the DC supply voltage V_{CC} for the operation of the PWM IC 311. The auxiliary coil 312 has Nₐᵤₓ turns, so when the PWM IC 311 is in the V_{CC} mode, the DC supply voltage V_{CC} will relate to the DC output voltage Vₒᵤₜ by the turn ratio Nₐᵤₓ/N_{S}. FIG. 7 shows the waveform diagram of the DC output voltage Vₒᵤₜ that traces the DC supply voltage V_{CC} in FIG. 6 when the turn ratio Nₐᵤₓ/N_{S}=2.7. In FIG. 7, the DC output voltage Vₒᵤₜ is kept within a range from a low voltage to a high voltage, wherein the low voltage is greater than 3.38V and the high voltage is greater than 3.94V due to the fact that the capacitance of the capacitor 314 is much smaller than that of the capacitor 305. When the NMOS transistor 315 is turned off, the voltage of the DC supply voltage V_{CC} will drop faster than the DC output voltage Vₒᵤₜ due to the capacitance difference between the capacitor 314 and the capacitor 305, so that as the DC supply voltage V_{CC} drops to 10.5V, the DC output voltage Vₒᵤₜ is still above 3.38V.

The NMOS transistor 315, responsive to the gating signal V_{G}, is used to control the power conversion via the main transformer 303.

The resistor 316 is used to carry the current sensing signal V_{CS}.

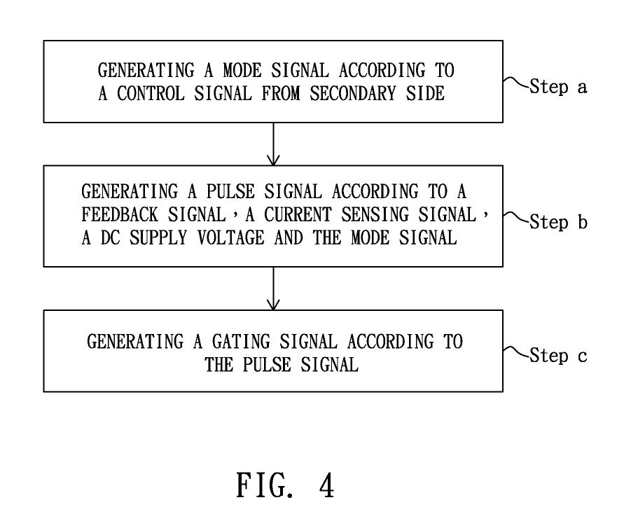

Please refer to FIG. 4, which shows the flow chart of a standby power saving method for an AC-to-DC power adapter according to a preferred embodiment of the present invention. As shown in FIG. 6, the method includes the steps of: generating a mode signal according to a control signal from secondary side(step a); generating a pulse signal according to a feedback signal, a current sensing signal, a DC supply voltage and the mode signal (step b); and generating a gating signal according to the pulse signal(step c).

In step a, the mode signal is generated according to voltage comparison of a feedback signal and a threshold voltage, wherein the mode signal has a normal mode state and a standby mode state.

In step b, the pulse signal is generated according to the mode signal, wherein the pulse signal has a normal PWM mode responsive to the normal mode state of the mode signal, and a V_{CC} mode responsive to the standby mode state of the mode signal. The normal PWM mode of the pulse signal is responsive to the feedback signal and to a current sensing signal for generating a DC output voltage. The V_{CC} mode of the pulse signal is responsive to the DC supply voltage to keep the DC supply voltage within a range from a first reference voltage to a second reference voltage, wherein the DC supply voltage is rectified from an auxiliary coil. The DC supply voltage in the V_{CC} mode is related to the DC output voltage by a turn ratio of the auxiliary coil to a secondary side coil.

In step c, the gating signal generated according to the pulse signal is used for driving a primary side power switch.

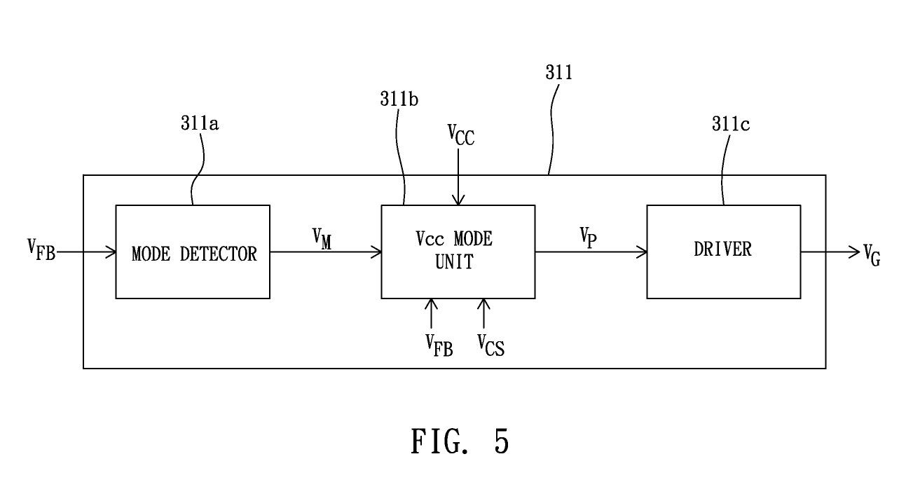

Please refer to FIG. 5, which shows the block diagram of a standby power saving apparatus for an AC-to-DC power adapter according to a preferred embodiment of the present invention. As shown in FIG. 5, the standby power saving apparatus 311 includes a mode detector 311a, a V_{CC} mode unit 311b and a driver 311c.

The mode detector 311a is used for generating a mode signal V_{M} according to voltage comparison of the feedback signal V_{FB} and a threshold voltage, wherein the mode signal V_{M} has a normal mode state and a standby mode state.

The V_{CC} mode unit 311b is used for generating a pulse signal V_{P} according to the mode signal V_{M}, wherein the pulse signal V_{P} has a normal PWM mode responsive to the normal mode state of the mode signal V_{M}, and a V_{CC} mode responsive to the standby mode state of the mode signal V_{M}. The normal PWM mode of the pulse signal V_{P} of the V_{CC} mode unit 311b is responsive to the feedback signal V_{FB} and to a current sensing signal V_{CS} for generating a DC output voltage. The V_{CC} mode of the pulse signal V_{P} of the V_{CC} mode unit 311b is responsive to a DC supply voltage V_{CC} to keep the DC supply voltage within a range from a first reference voltage to a second reference voltage, wherein the DC supply voltage is rectified from an auxiliary coil and the DC supply voltage in the V_{CC} mode of the V_{CC} mode unit 311b is related to the DC output voltage by a turn ratio of the auxiliary coil to the secondary side coil.

The driver 311c is used for generating a gating signal V_{G} according to the pulse signal V_{P} for driving the primary side power switch.

Through the implementation of the present invention, a more power saving performance in standby mode for power module applications is achieved. The lowered DC output voltage in standby mode of the present invention does reduce the standby power consumption even by around 30%.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A standby power saving method for power module applications, comprising the steps of:
generating a mode signal according to voltage comparison of a feedback signal and a threshold voltage, wherein said mode signal has a normal mode state and a standby mode state;
generating a pulse signal according to said mode signal, wherein said pulse signal has a normal PWM mode responsive to said normal mode state of said mode signal, and a V_{CC} mode responsive to said standby mode state of said mode signal; and
generating a gating signal according to said pulse signal for driving a primary side power switch.

2. The method according to claim 1, wherein said normal PWM mode of said pulse signal is responsive to said feedback signal and to a current sensing signal for generating a DC output voltage.

3. The method according to claim 2, wherein said V_{CC} mode of said pulse signal is responsive to a DC supply voltage to keep said DC supply voltage within a range from a first reference voltage to a second reference voltage, wherein said DC supply voltage is rectified from an auxiliary coil.

4. The method according to claim 3, wherein said DC supply voltage in said V_{CC} mode is related to said DC output voltage by a turn ratio of said auxiliary coil to a secondary side coil.

5. A standby power saving apparatus for power module applications, comprising:
a mode detector, used for generating a mode signal according to voltage comparison of a feedback signal and a threshold voltage, wherein said mode signal has a normal mode state and a standby mode state;
a V_{CC} mode unit, used for generating a pulse signal according to said mode signal, wherein said pulse signal has a normal PWM mode responsive to said normal mode state of said mode signal, and a V_{CC} mode responsive to said standby mode state of said mode signal; and
a driver, used for generating a gating signal according to said pulse signal for driving a primary side power switch.

6. The apparatus according to claim 5, wherein said normal PWM mode of said pulse signal of said V_{CC} mode unit is responsive to said feedback signal and to a current sensing signal for generating a DC output voltage.

7. The apparatus according to claim 6, wherein said V_{CC} mode of said pulse signal of said V_{CC} mode unit is responsive to a DC supply voltage to keep said DC supply voltage within a range from a first reference voltage to a second reference voltage, wherein said DC supply voltage is rectified from an auxiliary coil.

8. The apparatus according to claim 7, wherein said DC supply voltage in said V_{CC} mode of said V_{CC} mode unit is related to said DC output voltage by a turn ratio of said auxiliary coil to a secondary side coil.

9. The apparatus according to claim 5, further comprises:
a programmable shunt regulator, having a first input coupled to said DC output voltage, a second input coupled to a control signal, and an output for generating a secondary side feedback signal, wherein said control signal has a standby state and an active state that when said control signal is at said standby state, said secondary side feedback signal is fixed at a voltage level, and when said control signal is at said active state, said secondary side feedback signal is responsive to said DC output voltage; and
a photo-coupler, having an input side and an output side, wherein said input side is coupled to said secondary side feedback signal, and said output side is used for generating said feedback signal.
